(19) United States
(12) Patent Application Publication
(10) Pub. No.: US 2004/0212303 A1
(43) Pub. Date: Oct. 28, 2004

(54) Address electrode structure for plasma display panel

(75) Inventors: Hsu-Pin Kao, Ping Chen City (TW); Chih-Kuang Lin, Gau Shu Hsiang (TW); Yu-Yi Hsu, Chiayi City (TW); Chung-Wang Chou, Chung Li (TW)

Correspondence Address: SUGHRUE MION, PLLC, 2100 PENNSYLVANIA AVENUE, N.W., SUITE 800, WASHINGTON, DC, 20037, US

(73) Assignee: CHUNGHWA PICTURE TUBES LTD.

(21) Appl. No.: 10/419,745

(22) Filed: Apr. 22, 2003

(51) Int. Cl. H01J 17/49

(52) U.S. Cl. 313/582

(57) ABSTRACT

The present invention provides an address electrode structure for a plasma display panel. The address electrode structure of the present invention has two conductor lines that are partially connected together. The connected part approximates the adjoined parts of the X electrode and the Y electrode in the illumination units.

### FIELD OF THE INVENTION

The present invention relates to a plasma display panel (PDP), and more particularly to an address electrode structure for a PDP.

### BACKGROUND OF THE INVENTION

User demand for entertainment equipment is particularly high as a result of the rapid development of multimedia applications. Conventionally, the cathode ray tube (CRT) display, which is a type of monitor, is commonly used. However, the cathode ray tube display does not meet the needs of multimedia technology because of the large volume thereof. Therefore, many flat panel display techniques such as liquid crystal display (LCD), plasma display panel (PDP), and field emission display (FED) have been recently developed. Of these techniques, the plasma display panel (PDP) is attracting attention in the field of displays as a full-color display apparatus having a large size display area and is especially popularly when utilized for a large size television or an outdoor display panel. This is because of its capability for high quality display resulting from the fact that it is of a self-light emitting-type with a wide angle of visibility and high speed of response, as well as its suitability to upsizing due to its simple manufacturing process.

A color PDP is a display in which ultraviolet rays are produced by gas discharge to excite phosphorus so that visible light is emitted therefrom to perform a display operation. Depending upon a discharge mode, the color PDP is classified into an alternating current (AC) or a direct current (DC) type. In the AC-type PDP, an electrode is covered with a protective layer. The AC-type PDP has characteristics such as an inherent long life and a high brightness. Therefore, the AC-type PDP is commonly superior to the DC-type PDP in luminance, luminous efficiency and lifetime.

Generally, a 3-electrode-type PDP including a common electrode, a scan electrode (X electrode and Y electrode) and an address electrode is employed in the AC-type PDP. The 3-electrode-type is directed to a surface discharge-type and is switched or sustained based on a voltage applied to the address electrode installed at a lateral surface of a discharge cell. In particular, the common and scan electrodes formed on an image display side substrate are formed of a transparent electrode made of a glass material for implementing a certain transmittivity of visual ray. A non-transparent electrode having a small width, generally referred to as a bus electrode, is used integrally with respect to the transparent electrodes. The transparent electrode material is a semiconductor typically formed of ITO (e.g., a mixture of indium oxide In2O3 and tin oxide SnO2). The conductivity of the transparent electrode is low in comparison with that of metal, and therefore a narrow width and fine conductive layer is added as the bus electrode on the transparent electrode to enhance its conductivity.

When an address discharge voltage is supplied to the scan electrode and a corresponding address electrode, an address discharge is generated between the scan electrode and the address electrode. An electric field is formed in the interior of a corresponding illumination unit, the electrons of the discharge gases are accelerated, and the accelerated electrons collide with ions. At this time, the ionized electrons collide with neutron particles, so that the neutron particles are ionized into electrons and ions at high speed, whereby discharge gas becomes a plasma, and a vacuum ultraviolet ray is formed.

Typically, a single conductor line with the same width is used to form the address electrode, wherein the width of the conductor line should be narrow as far as possible to avoid generating capacitor effect thereon. However, the typically narrow address structure may reduce the writing velocity of the PDP. The single conductor line is only capable of carrying a little current.

### SUMMARY OF THE INVENTION

It is an object of the present invention to provide an address electrode structure having two conductor lines to raise the capability of carrying current.

It is another object of the present invention to provide an address electrode structure formed by two conductor lines that are connected together approximating the adjoined part of the X electrode and the Y electrode in the illumination units. The connected part can raise the writing velocity.

It is yet another object of the present invention to provide an address electrode structure that can reduce the defect effect happening thereon.

Therefore, the present invention provides an address electrode structure for a plasma display panel. The address electrode structure of the present invention comprises two conductor lines that are partially connected together. The connected part approximates the adjoined part of the X electrode and the Y electrode in the illumination unit.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic top view of an address electrode for a plasma display panel according to one preferred embodiment of the present invention;

FIG. 2 is a schematic top view of an address electrode for a plasma display panel according to one preferred embodiment of the present invention, in which a defect occurs in the address electrode structure;

FIG. 3 is a schematic top view of an address electrode for a plasma display panel according to one preferred embodiment of the present invention;

FIG. 4 is a schematic perspective view of a plasma display panel having an address electrode according to the present invention; and

FIG. 5 is a cross-sectional view of FIG. 4.

### DETAILED DESCRIPTION OF THE PREFERRED EMBODIMENT

Without limiting the spirit and scope of the present invention, the address electrode structure proposed in the present invention is illustrated with one preferred embodiment. One or ordinary skill in the art, upon acknowledging the embodiment, can apply the address electrode structure of the present invention to various plasma display panel. Each address electrode structure comprises two conductor lines that are partially connected together. The connected part approximates the adjoined part of the X electrode and the Y electrode in the illumination unit. The connected part may raise the writing velocity. The application of the present invention is not limited by the preferred embodiments described in the following.

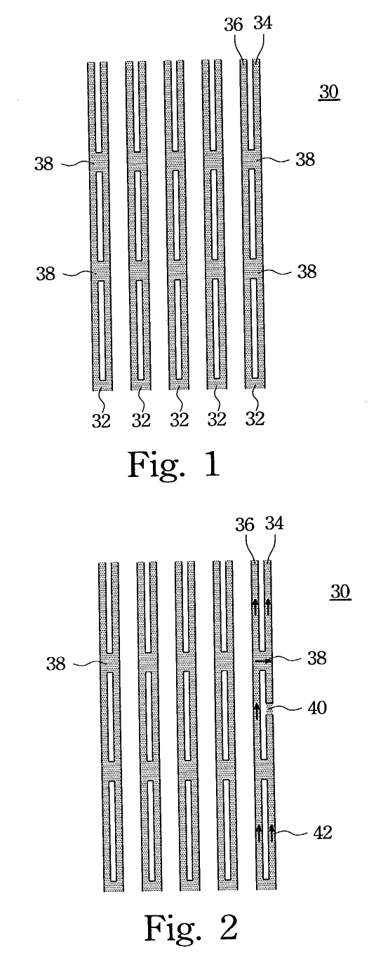

FIG. 1 shows a schematic top view of an address electrode for a plasma display panel according to one preferred embodiment of the present invention. The address electrode structure 30 of the present invention is composed of a plurality of address electrodes 32 arranged in parallel to each other. Each address electrode 32 comprises two conductor lines 34 and 36 that are partially connected together. The connected part 38 approximates the adjoined part of the X electrode and the Y electrode in the illumination unit. The connected part 38 has a larger area that may form a larger capacitor to increase the writing velocity of a PDP. The remaining part of the address electrode structure in an illumination unit has a relatively small area that can reduce power consumption. Moreover, each address electrode 32 composed by two conductor lines can have a higher carrying current capacity than the conventional address electrode composed of single conductor line.

FIG. 2 shows a schematic top view of an address electrode according to the present invention, in which a defect 40 occurs in one of the two conductor lines of an address electrode. Because each address electrode 32 is composed of two conductor lines, the current can flow to another conductor line of this address electrode that is not affected by a defect. The direction of this current is shown by the arrow 42. In contrast, the conventional address electrode is composed of a single conductor line. Once a defect occurs in the single conductor line, the electricity of the final product may be affected.

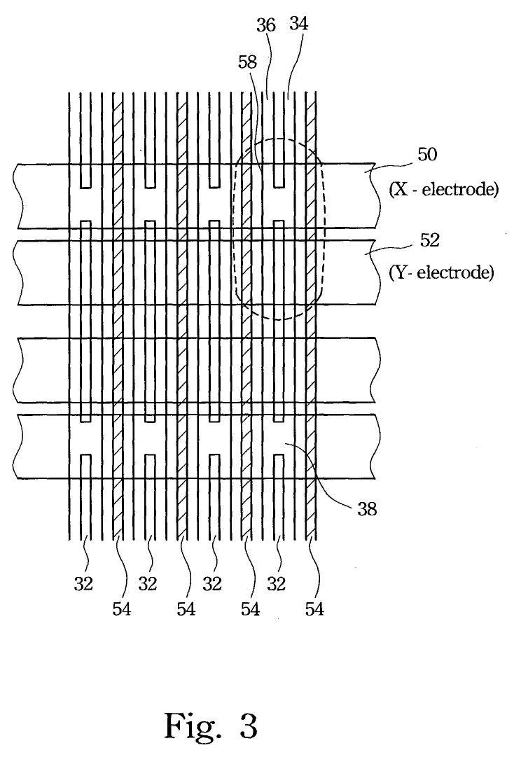

FIG. 3 is a schematic top view of an address electrode for a plasma display panel according to one preferred embodiment of the present invention. A pair of transparent electrodes 50 and 52 are used and disposed opposite the illumination units, respectively. Bus electrodes (not shown in the figure) are formed over the transparent electrodes to reduce their resistance. For a three electrode structure, the three electrodes of the illumination unit 58 includes the adjacent and parallel transparent electrodes 50 and 52 (X electrode and Y electrode) formed in the front plate and the address electrode formed in the corresponding position in the back plate.

The connected part 38 can raise the writing velocity when a voltage is applied to a specific discharge unit because it has a larger area and is approximately located in the adjoined parts of the X electrode and the Y electrode in the illumination units. On the other hand, the other part of the address electrode of the illumination unit 58 is located in a smaller area, which avoids power consumption.

The illumination units 58 are separated by barrier ribs 54, for example, a plurality of parallel strips, the illumination units 58 being formed therebetween. In accordance with the preferred embodiment, the transparent electrodes 50 and 52 are formed in a strip sharp. However, it is noticed that the transparent electrodes with any sharps may be used to combine with the address electrode provided by the present invention to form a illumination unit.

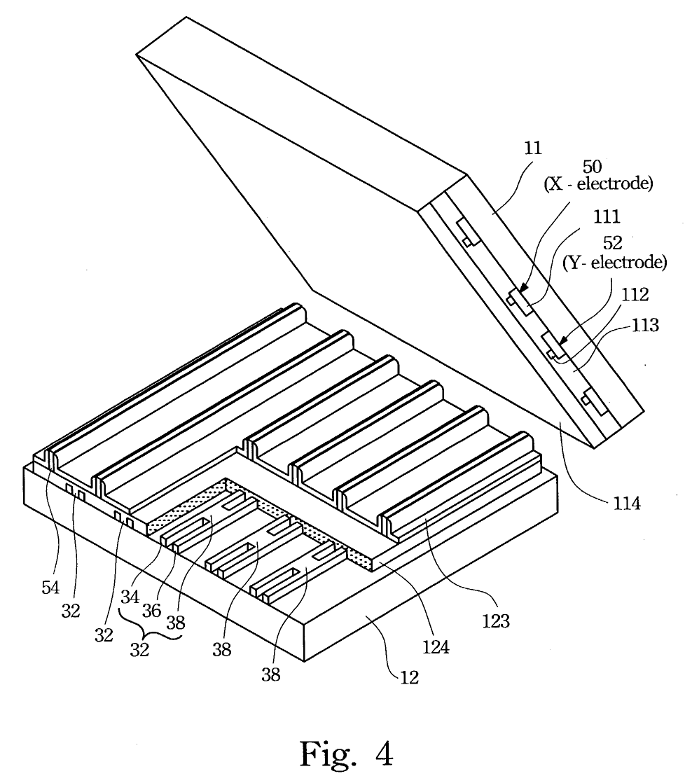

FIG. 4 is a schematic perspective view of a plasma display panel of which having an address electrode according to the present invention. Referring to FIG. 4 and FIG. 3 together, a plasma display panel comprises a front plate 11 and a back plate 12. A plurality of parallel transparent electrodes 111 (X electrode 50 and Y electrode 52) and bus electrodes 112, a dielectric layer 113 and a protective layer 114 are sequentially formed on the front plate 11. A plurality of parallel address electrodes 32, a plurality of parallel barrier ribs 54, a fluorescencer 123 and a dielectric layer 124 are formed on the back plate 12. Each address electrode 32 is composed of two conductor lines 34 and 36 that are partially connected together. The connected part 38 approximates the adjoined parts of the X electrode and the Y electrode in the illumination unit. One transparent electrode 111 on the front plate 11 and one address electrode 32 on the back plate 12 are formed perpendicular to each other to compose a discharge unit. When a voltage is applied to a specific discharge unit, gas discharge occurs at the discharge unit between the dielectric layers 113 and 124 to induce emission of a colored visible light from the fluorescencer 123.

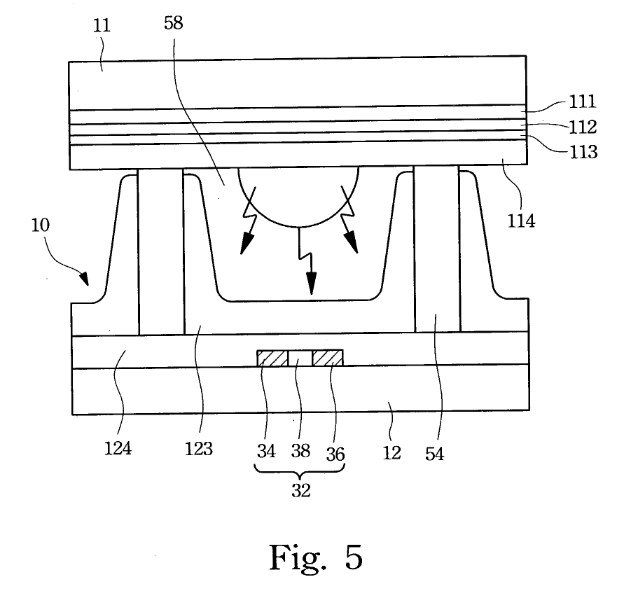

FIG. 5 is a schematic, cross-sectional view corresponding to FIG. 4. Referring to FIG. 4 and 5 simultaneously, in one discharge unit 58, a three-electrode structure, including an X electrode and an Y electrode of the transparent electrode 111 on the front plate 11 and an address electrode 32 on the back plate 12, is generally employed. Each address electrode 32 is composed of two conductor lines 34 and 36 that are partially connected together to form connected parts 38. When a voltage is applied to the above three electrodes of a specific discharge unit 58 to induce discharge, the mixed gas in the discharge unit 58 emits ultraviolet (UV) rays to light the fluorescencer 123 inside the discharge unit 58. The fluorescencer 123 then emits a visible light, such as a red (R), green (G) or blue (B) light. An image is thus produced by scanning the discharge unit array.

According to above descriptions, the present invention provides a address electrode structure for a plasma display panel. The address structure of the present invention is composed of a plurality of address electrode arranged in parallel to each other. Each address electrode structure comprises two conductor lines that are partially connected together. The connected part approximates the adjoined part of the X electrode and the Y electrode in the illumination unit. The connected part can raise the writing velocity. On the other hand, the two conductor lines may reduce the effect of defects occurring therein.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. An address electrode structure for a plasma display panel comprising a front substrate, a back substrate and a plurality of illumination units, wherein each illumination unit is controlled by an X electrode and a Y electrode both disposed in said front substrate and a address electrode disposed in said back plate, said address electrode structure comprising:
two conductor lines located in said back substrate and arranged in parallel to each other; and
a plurality of conductor pieces located between said two conductor and separated from each other, wherein said conductor pieces are used to couple said two conductor lines.

2. The address electrode structure according to claim 1, wherein said conductor pieces are respectively located in positions approximating adjoined parts of the X electrode and the Y electrode in the illumination units.

3. An address electrode structure for a plasma display panel comprising a front substrate, a back substrate and a plurality of illumination units, wherein each illumination unit is controlled by an X electrode and a Y electrode both disposed in said front substrate and a address electrode disposed in said back plate, said address electrode structure comprising:
two conductor lines located in said back substrate and arranged in parallel to each other; and
a plurality of conductor pieces separated from each other and located between said two conductor to couple said two conductor lines, wherein said conductor pieces are respectively located in positions approximating adjoined parts of the X electrode and the Y electrode in the illumination units.
